(19) United States
(12) Patent Application Publication
(10) Pub. No.: US 2006/0148458 A1
(43) Pub. Date: Jul. 6, 2006

(54) Time service for telephone calls

(76) Inventors: Eshwari P. Komaria, Bangalore, IN (US); Vincent Zimmer, Federal Way, WA (US)

Correspondence Address: BUCKLEY, MASCHOFF, TALWALKAR LLC, 5 ELM STREET, NEW CANAAN, CT, 06840, US

(21) Appl. No.: 11/028,817

(22) Filed: Jan. 4, 2005

(51) Int. Cl. H04M 3/42

(52) U.S. Cl. 455/415

(57) ABSTRACT

According to some embodiments, a destination telephone identifier associated with a destination telephone is determined. For example, a caller might enter a telephone number of the destination telephone. A current local time associated with the destination telephone may then be determined. For example, a local time of day may be determined based on the current location of the destination telephone.

### BACKGROUND

When a person places a telephone call to a destination telephone, he or she may not realize the current local time associated with the destination telephone. For example, a person may place a telephone call from Boston in the United States, which uses Eastern Standard Time (EST), at 4:30 PM. If the person is calling London in the United Kingdom, which uses Greenwich Mean Time (GMT), the current local time for the destination party may be 9:30 PM. As a result, a person might inadvertently place a telephone call at an inappropriate time (e.g., too early in the morning or too late at night). Moreover, the increasing use of wireless telephones may make it more likely that such problems will occur. For example, a caller might place a telephone call to a friend who usually lives in New York, which uses EST, without realizing that the friend is currently in San Francisco, which uses Pacific Standard Time (PST). As a result, the caller may think he or she is calling the friend at 9:00 AM when the current local time is actually 6:00 AM.

### BRIEF DESCRIPTION OF THE DRAWINGS

FIG. 1 is a block diagram of a system according to some embodiments.

FIG. 2 is a flow diagram illustrating a method that may be used to determine time information according to some embodiments.

FIG. 3 is an information flow diagram according to some embodiments.

FIG. 4 is a block diagram of a system according to some embodiments.

FIG. 5 is a flow diagram illustrating a method that may be used to evaluate a rule according to some embodiments.

FIG. 6 illustrates a caller telephone according to some embodiments.

FIG. 7 is a tabular representation of a portion of a telephone rule database according to some embodiments.

FIG. 8 is a block diagram of a system according to some embodiments.

### DETAILED DESCRIPTION

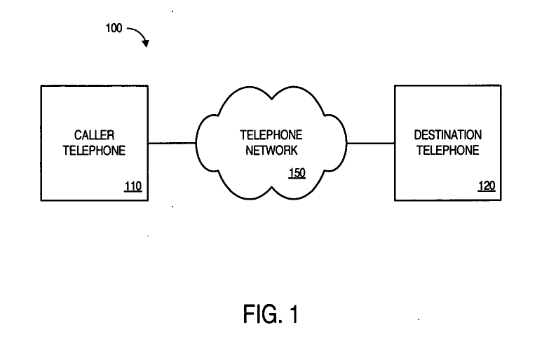

FIG. 1 is a block diagram of a system 100 according to some embodiments. In particular, the system includes a caller telephone 110 that can be used to place a telephone call to a destination telephone 120. As used herein, the word “telephone” may refer to any type of device that can be used to communicate verbally with another party. The caller telephone 110 and/or the destination telephone 120 may be, for example, a conventional land-line telephone, a wireless telephone, a Voice over Internet Protocol (VoIP) telephone, a Personal Computer (PC), a handheld computer, a Personal Digital Assistant (PDA), or a game device.

The caller telephone 110 and the destination telephone 120 may exchange signals via a telephone network 150. The telephone network 150 may include, for example, the Public Switched Telephone Network, an Internet Protocol (IP) network, a VoIP network, or a wireless telephone network. Moreover, the telephone network 150 may be associated with a caller telephone service provider, a destination telephone service provider, and/or a third-party service provider. Note that different devices and networks might be included in the telephone network 150, such as various switches, routers, local central offices, end offices, local exchange carriers, and/or interoffice trunks.

In some cases, the caller telephone 110 will be at a location that uses one time zone while the destination telephone 120 is at a different location that uses a different time zone. As a result, a caller might mistakenly place a telephone call at an inappropriate time. Moreover, when the destination telephone 120 is a wireless telephone, there might not be a way for a calling party to determine the current local time associated with the destination telephone's location. For example, the destination party might have brought his or her destination telephone 120 to another country.

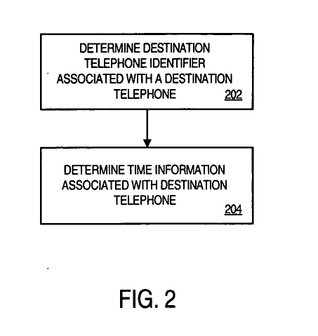

FIG. 2 is a flow diagram illustrating a method that may be used to determine time information according to some embodiments. The method may be performed, for example, using the system 100 of FIG. 1. The flow charts described herein do not necessarily imply a fixed order to the actions, and embodiments may be performed in any order that is practicable. Note that any of the methods described herein may be performed by hardware, software (including microcode), firmware, or any combination of these approaches. For example, a storage medium may store thereon instructions that when executed by a machine result in performance according to any of the embodiments described herein.

At 202, a destination telephone identifier associated with a destination telephone is determined. The destination telephone identifier might be, for example, a telephone number assigned to the destination telephone. Note that other types of identifiers could also be used instead of, or in addition to, the destination telephone number, such as an Electronic Serial Number (ESN), a Mobile Identification Number (MIN), and/or a System Identification (SID) code.

The destination telephone identifier might be determined, for example, by the caller telephone 110. For example, the caller telephone 110 might determine the destination telephone identifier when a caller enters the number via a telephone keypad. A device in the telephone network 150 might also determine the destination telephone identifier. For example, a time service provider remote from the caller telephone 110 might determine the destination telephone identifier based on information received from the caller telephone 110 (e.g., the telephone number assigned to the destination telephone 120 might be included in a request transmitted from the caller telephone to the time service provider).

At 204, time information associated with the destination telephone 120 is determined. The time information might include, for example, a current or local time associated with the location of the destination telephone 120 (e.g., indicating that it is 3:00 AM where the destination telephone 120 is located).

According to some embodiments, a time offset may be determined (e.g., indicating that the current local time associated with the destination telephone 120 is two hours behind the time associated with the caller telephone 110). In some cases, a time zone associated and/or a daylight savings time indication associated with the destination telephone 120 might be determined (e.g., indicating that the destination telephone 120 is in a location that uses GMT and that daylight savings is not currently in effect). According to other embodiments, the time information simply indicates the location of the destination telephone 120 (e.g., indicating that the destination telephone 120 is in Moscow). In this case, a database or another service might be used to generate the current local time associated with the destination telephone 120 based on the location information.

As still other examples, the time information might indicate a day of week and/or whether or not it is a workday where the destination telephone 120 is located. For example, the typical workweek in the United States is from Monday through Friday. In Iran, on the other hand, the typical workweek is from Sunday though Thursday. As a result, the time information might indicate (i) if it is currently a Saturday or Sunday when the destination telephone 120 is in the United States and (ii) if it is currently a Friday or Saturday when the destination telephone 120 is in Iran.

The time indication might indicate whether or not it is a holiday where the destination telephone 120 is located. For example, if a telephone call is placed on January 26th to a destination telephone 120 located in India, the time indication might indicate that it is currently a national holiday. In still another embodiment, the time indication is a time flag, such as a flag that indicates whether or not the current time at the destination telephone 120 is within normal working hours.

In the case of a land-line destination telephone 120, the time information might be determined based on a database of telephone numbers, country codes, area codes, or other available information. In the case of a wireless destination telephone 120, the time information might be based on a cell, antenna, or base station that last communicated with the wireless destination telephone 120. In other cases, the time information might be based on, or associated with, a satellite telephone network, Global Positioning Satellite information, and/or the MICROSOFT® NETWORK (MSN) Direct wireless network. According to another embodiment, a query is transmitted to the destination telephone 120, which provides the appropriate time information.

The time information may then be provided to a caller or the caller telephone 110. For example, the current local time associated with the destination telephone 120 might be displayed on the caller telephone 110.

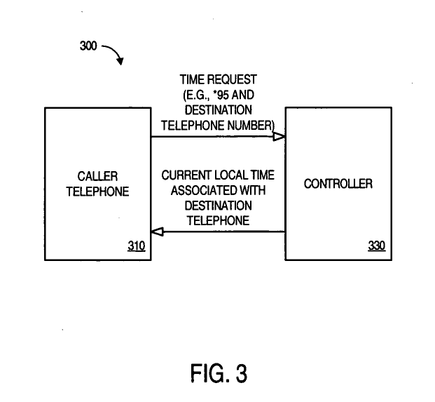

FIG. 3 is an information flow diagram 300 according to some embodiments. In this case, a caller telephone 310 provides a time request to a controller 330. For example, a caller may use a telephone keypad to enter a Dual-Tone Modulated Frequency (DTMF) code associated with a time request (e.g., by entering “*95”). The caller might then enter a telephone number associated with a destination telephone (e.g., a ten digit telephone number or a number that includes a country code). The controller 330 may then determine time information in accordance with any of the embodiments described herein and provide the time information to the caller telephone 310. For example, the controller 330 might provide the following message to the caller “It is currently 2:00 PM where the telephone associated with (555) 555-5555 is located.”

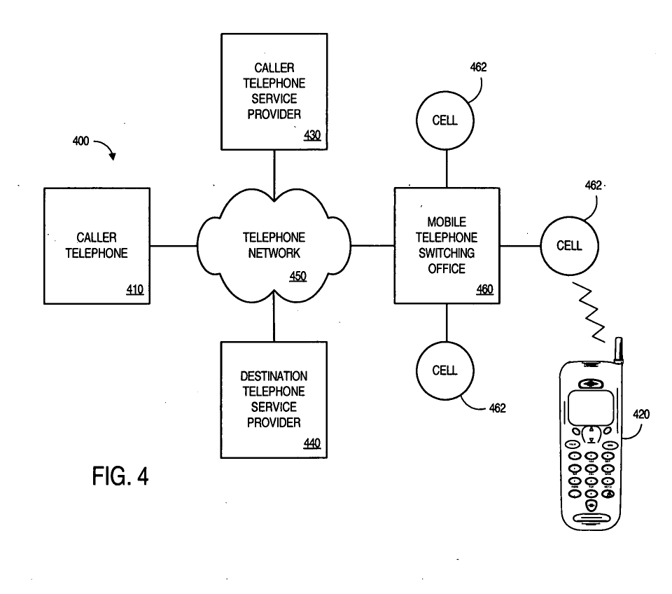

FIG. 4 is a block diagram of a system 400 according to some embodiments. As before, a caller may use a caller telephone 410 to place a telephone call to a wireless destination telephone 420 through a telephone network 450. In particular, the caller telephone 410 might initially exchange information with a caller telephone service provider 430. Based on the telephone number associated with the destination telephone 420, the caller telephone service provider 430 may then exchange information with a destination telephone service provider 440. Note that the destination telephone 420 might currently be located in an area such that it is using a telephone service provider other than the destination telephone service provider 440 (e.g., the phone is “roaming”).

The destination telephone 420 may exchange information with a Mobile Telephone Switching Office (MTSO) 460 through a nearby antenna cell 462. The last known location of the destination telephone 420 may then be registered and stored in a database (e.g., at the MTSO 460 and/or the destination telephone service provider 440). When the caller telephone 410 places a call to the destination telephone 420, the time information may then be determined based on the information in the database. For example, the caller telephone service provider 430 might forward a request to the destination telephone service provider 440 and receive a response indicating the current local time associated with the destination telephone 420. The caller telephone service provider 430 can then transmit the current local time to the caller telephone 410 so that it can be displayed to the caller.

In addition to displaying the destination telephone time information to a caller, the caller telephone 410 might use the time information to evaluate a rule. Consider, for example, a caller who never wants to place a telephone call when the current time associated with a destination telephone 420 is between 11:30 PM and 6:30 AM. In this case, the caller telephone 410 might prevent such a call from being placed based on the time information.

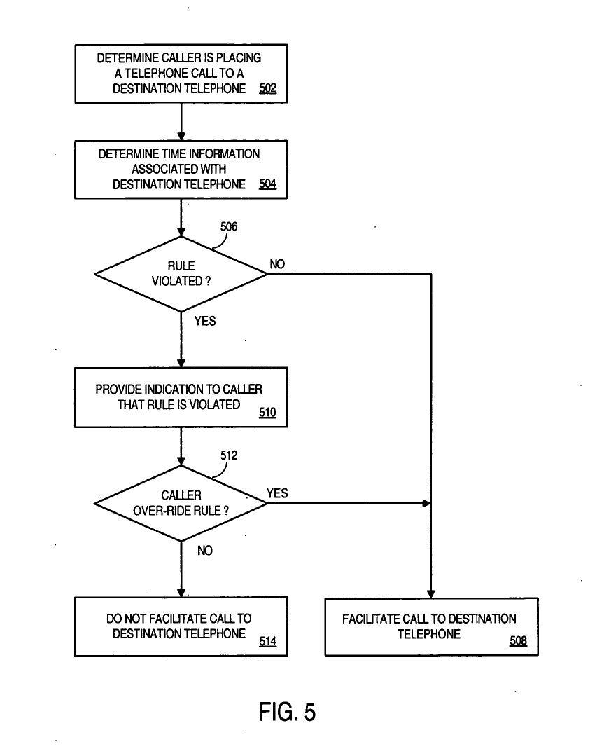

FIG. 5 is a flow diagram illustrating a method that may be used to evaluate a rule according to some embodiments. At 502, it is determined that a caller is placing a telephone call to a destination telephone. For example, a caller telephone might detect that the caller has dialed a telephone number. At 504, time information associated with the destination telephone is determined. For example, the caller's telephone might (i) transmit a time request along with the telephone number of the destination telephone and (ii) receive a response to the request including the current time at the destination telephone location.

At 506, a rule is evaluated based on the time information. The rule might indicate, for example, that a telephone call should not be permitted during between 11:30 PM and 6:30 AM. If the rule is not violated at 506 (e.g., it is currently 8:00 PM where the destination telephone is located), the call to the destination telephone may be facilitated at 508 (e.g., the caller telephone may complete the telephone call).

If the rule is violated at 506 (e.g., it is currently 2:15 AM where the destination telephone is located), an indication may be provided to the caller at 510. For example, the caller might be asked “It is 2:15 AM where that telephone is located, are you sure you want to place this telephone call?” If the caller does not over-ride the rule at 512, the telephone call is not facilitated at 514 (e.g., the caller telephone might terminate the telephone call). The caller may, however, decide to over-ride the rule at 512. For example, the caller might want to place a late night telephone call in an emergency situation. In this case, the telephone call is facilitated at 508 (e.g., the caller telephone may complete the telephone call).

Note that a device other than the caller telephone might perform the method described with respect to FIG. 5. For example, a caller telephone service provider device might store and evaluate rules for subscribers.

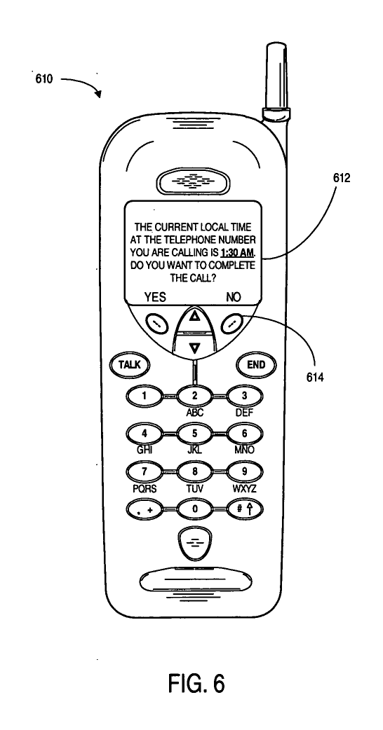

FIG. 6 illustrates a caller telephone 610 including a display 612 showing a caller time information associated with a destination telephone. In particular, the display 612 indicates that a rule is being violated, and the caller can use a keypad input 614 to indicate whether or not the telephone call should be completed.

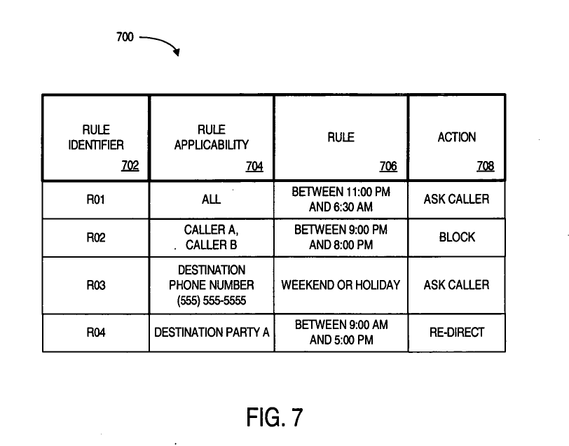

More than one rule might be used to evaluate telephones calls. For example, one rule might apply to one set of destination telephone numbers (e.g., the caller's work acquaintances) and another rule might apply to another set of destination telephone numbers (e.g., the caller's friends and family). FIG. 7 is a tabular representation of a portion of a rule database 700 that might be used to store rules according to some embodiments. The illustration and accompanying description of the database 700 presented herein is exemplary, and any number of other database arrangements could be employed besides those suggested by the figure.

Referring to FIG. 7, a table represents the telephone rule database 700 that might be stored, for example, at a telephone or a telephone service provider. The table includes entries identifying rules that might be used to evaluate telephone calls. The table also defines fields 702, 704, 706, 708 for each of the entries. The fields specify: a rule identifier 702, a rule applicability 704, a rule 706, and an action 708. The information in the telephone rule database 700 may be created and updated, for example, based on information received from a calling party.

The rule identifier 702 may be, for example, an alphanumeric code associated with a rule. The rule applicability 704 might indicate, for example, which telephone calls should be evaluated using the rule. In some cases, for example, a rule will be evaluated for every telephone call that is placed. According to some embodiments, a rule might only be applied for particular types of callers (e.g., parents or children), destination telephone numbers, or destination parties.

The rule 706 indicates how the time information may be evaluated. For example, the rule 706 might indicate that calls should not be made between certain times, during certain days of the week, or during certain days of the year (e.g., holidays). Consider the rule 706 associated having rule identifier 702 “R04.” In this case, the rule checks to see if the telephone call is being placed when the local time at the destination telephone is between 9:00 AM and 5:00 PM (e.g., because the caller does not want to disturb destination party A while he or she is working).

The action 708 indicates what should be done when a rule 706 is violated by a telephone call. The action 708 might be, for example, to block a telephone call or to ask the caller if he or she would like to over-ride the rule 706. According to some embodiments, the action 708 might be to re-direct the telephone call (e.g., to voice mail or to another telephone number or person).

The rules 700 in a database may be entered or selected, for example, by a caller. According to another embodiment, a rule might also be based on a destination party preference. For example, the destination telephone might transmit a rule to a caller telephone indicating that the destination party prefers to not receive calls between 8:00 PM and 8:00 AM.

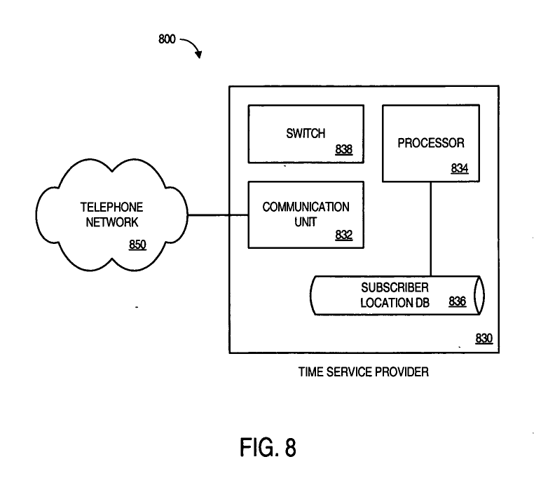

FIG. 8 is a block diagram of a system 800 according to some embodiments. In this case, a time service provider 830 network device may exchange information through a telephone network 850 using a communication unit 832 (e.g., adapted to exchange information packets). Note that the time service provider 830 might be distributed between multiple locations and/or parties. The time service provider 830 includes a processor 834, such as an INTEL PENTIUM® processor, adapted to provide time information associated with a destination telephone in accordance with any of the embodiments described herein. The processor 834 may determine time information, for example, based at least in part on information stored in a subscriber location database 836. The time service provider 830 further includes a switch 838, such as a switch adapted to facilitate telephone call routing.

The following illustrates various additional embodiments. These do not constitute a definition of all possible embodiments, and those skilled in the art will understand that many other embodiments are possible. Further, although the following embodiments are briefly described for clarity, those skilled in the art will understand how to make any changes, if necessary, to the above description to accommodate these and other embodiments and applications.

Although particular rules have been provided as examples, note other types of rules might be evaluated. For example, a rule might indicate that call a telephone call should not normally be placed if the destination telephone is in another country or in a country on a list of prohibited countries (e.g., when the call is being placed from a classified government office).

As another example, an automatic rule might prohibit a telephone call if the cost of the telephone call will exceed a predetermined limit (e.g., a caller might be asked if he or she wants to complete a telephone call when the location of the destination telephone results in a cost of more than $1.00 per minute). As still another example, the cost of a telephone call might be determined by a service provider and displayed to the caller before the telephone call is completed (e.g., when the caller is using a public pay telephone or is calling from a hotel room). The cost of the telephone call might be determined, at least in part, based on a time and/or location associated with the destination telephone and/or a billing information database.

Moreover, embodiments may apply to communications other than telephone calls, including paging services, Short Message Service (SMS) messaging, and other types of text messages.

The several embodiments described herein are solely for the purpose of illustration. Persons skilled in the art will recognize from this description other embodiments may be practiced with modifications and alterations limited only by the claims.

What is claimed is:

1. A method, comprising:
determining a destination telephone identifier associated with a destination telephone; and
determining time information associated with the destination telephone.

2. The method of claim 1, wherein the time information comprises at least one of: (i) a current time, (ii) a local time, (iii) a time offset, (iv) a time zone, (v) a daylight savings time indication, or (vi) a destination time preference.

3. The method of claim 1, wherein the method is performed at a controller.

4. The method of claim 3, wherein said determining the destination telephone identifier comprises:
receiving from a remote telephone device a time request including a destination telephone number.

5. The method of claim 4, further comprising:
providing to the remote telephone device an indication of a current time associated with the destination telephone.

6. The method of claim 4, further comprising:
forwarding the request to a telephone service provider associated with the destination telephone.

7. The method of claim 1, wherein said determining the time information includes determining a location associated with a wireless telephone.

8. The method of claim 1, wherein the method is performed at a telephone device.

9. The method of claim 1, further comprising:
performing an evaluation in accordance with the time information associated with the destination telephone.

10. The method of claim 9, wherein the evaluation is further based on at least one of: (i) the destination telephone identifier, (ii) a caller identifier, (iii) a destination party identifier, (iv) a rule, (v) a caller preference, and (vi) a destination party preference.

11. The method of claim 9, further comprising:
providing an indication to a caller based on the evaluation.

12. The method of claim 11, further comprising:
receiving from the caller a response to the indication; and
facilitating a telephone call to the destination telephone based on the response.

13. The method of claim 1, wherein the time information includes at least one of: (i) a time of day, (ii) a day of week, (iii) weekend information, (iv) holiday information, or (v) a time flag.

14. An apparatus comprising:
a storage medium having stored thereon instructions that when executed by a machine result in the following:
receiving from a caller telephone a time request including a destination telephone identifier associated with a wireless destination telephone,
determining a current time associated with the wireless destination telephone, and
transmitting to the caller telephone an indication of a current local time associated with the wireless destination telephone.

15. The apparatus of claim 14, wherein said determining comprises:
transmitting a request to a telephone service provider associated with the wireless destination telephone; and
receiving an indication of the current local time from the telephone service provider.

16. The apparatus of claim 14, wherein the current time is determined based on least in part on the location of a cell site associated with a mobile telephone switching office.

17. A method, comprising:
setting at least one rule associated with telephone calls;
determining a destination telephone identifier;
determining a current local time associated with a location of a destination telephone having the destination telephone identifier; and
evaluating if the rule is satisfied based at least in part on the current local time.

18. The method of claim 17, further comprising:
displaying a result of the evaluation to a caller.

19. The method of claim 17, wherein said determining the telephone identifier includes transmitting a request to a remote controller.

20. A system, comprising:
a network device to (i) receive a time request from a caller telephone, the time request including a destination telephone number and (ii) transmit an indication of time information associated with a destination telephone; and
a switch to facilitate a telephone call to the destination telephone.

21. The system of claim 20, wherein the request is received via dual-tone modulated frequency signals.

22. The system of claim 20, wherein at least one of the network device and the switch are associated with at least one of: (i) a public switched telephone network, (ii) an Internet protocol network, (iii) a voice over Internet protocol network, or (iv) a wireless telephone network.

23. The system of claim 20, wherein at least one of the caller telephone and the destination telephone comprises at least one of: (i) a land-line telephone, (ii) a wireless telephone, (iii) a voice over Internet protocol telephone, (iv) a personal computer, (v) a handheld computer, (vi) a personal digital assistant, or (vii) a game device.

24. A method, comprising:
determining a destination telephone identifier associated with a destination telephone; and
determining at least one of: (i) location information associated with the destination telephone, or (ii) cost information associated with a telephone call to the destination telephone; and
facilitating presentation of the determined information to a caller.

25. The method of claim 24, wherein the presentation is associated with at least one of: (i) an audio message, (ii) a displayed message, and (iii) an automated rule.

26. The method of claim 24, wherein the method is performed at a controller.

27. The method of claim 26, wherein said determining the destination telephone identifier comprises:
receiving from a remote telephone device a time request including a destination telephone number.
